(19) United States
(12) Patent Application Publication
(10) Pub. No.: US 2017/0102704 A1
(43) Pub. Date: Apr. 13, 2017

(54) Automated Vehicle Object Detection Device With Level Detection

(71) Applicant: Delphi Technologies, Inc., Troy, MI (US)

(72) Inventors: Gary J. O'Brien, Palo Alto, CA (US); Mark A. Lynn, Carmel, IN (US)

(21) Appl. No.: 15/052,056

(22) Filed: Feb. 24, 2016

Related U.S. Application Data
(60) Provisional application No. 62/240,630, filed on Oct. 13, 2015.

(51) Int. Cl. G05D 1/02; G01C 9/08; G01P 15/08; G01S 17/93

(52) U.S. Cl. CPC G05D 1/024; G01S 17/936; G01C 9/08; G01P 15/0802; G05D 1/0257

(57) ABSTRACT

An object-detection system suitable for an automated vehicle includes an object-detection device and an accelerometer. The object-detection device is configured to be installed on a vehicle. The object-detection device is operable to detect an object proximate to the vehicle. The accelerometer is coupled to the object-detection device. The accelerometer operable to determine an orientation-angle of the object-detection device relative to a gravity-direction.

### CROSS-REFERENCE TO RELATED APPLICATION

This application claims the benefit under 35 U.S.C. §119(e) of U.S. Provisional Patent Application No. 62/240,630, filed 13 Oct. 2015, the entire disclosure of which is hereby incorporated herein by reference.

### TECHNICAL FIELD OF INVENTION

This disclosure generally relates to an object-detection system suitable for an automated vehicle, and more particularly relates to using an accelerometer to determine an orientation-angle of the object-detection device relative to a gravity-direction.

### BACKGROUND OF INVENTION

It is known that the orientation angle of an object-detection device (e.g. Light Detection And Ranging device (LIDAR), Radio Detection And Ranging device (RADAR), and imaging device, e.g. a video camera) relative to the field-of-view that the object-detection device is observing needs to be known so the range and/or direction to an object can be accurately determined. However, once one or more of these devices is installed in a vehicle, the orientation-angle of the device relative to the vehicle and/or the ground over which the vehicle travels may change due to, for example, vibration, vehicle-collision damage, and/or vehicle loading.

### SUMMARY OF THE INVENTION

In accordance with one embodiment, an object-detection system suitable for an automated vehicle is provided. The system includes an object-detection device and an accelerometer. The object-detection device is configured to be installed on a vehicle. The object-detection device is operable to detect an object proximate to the vehicle. The accelerometer is coupled to the object-detection device. The accelerometer operable to determine an orientation-angle of the object-detection device relative to a gravity-direction.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a side view of a vehicle equipped with an object-detection system in accordance with one embodiment;

FIG. 2 is a diagram of the system of FIG. 1 in accordance with one embodiment; and

FIG. 3 is a flowchart of a method to operate the system of FIG. 1 in accordance with one embodiment.

### DETAILED DESCRIPTION

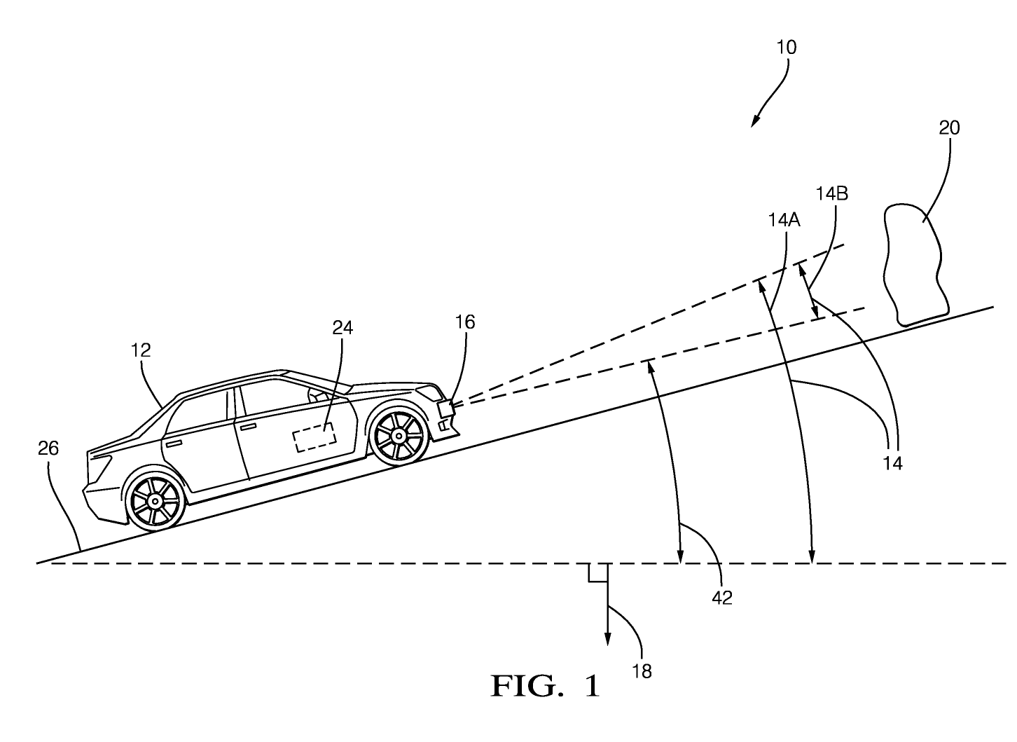

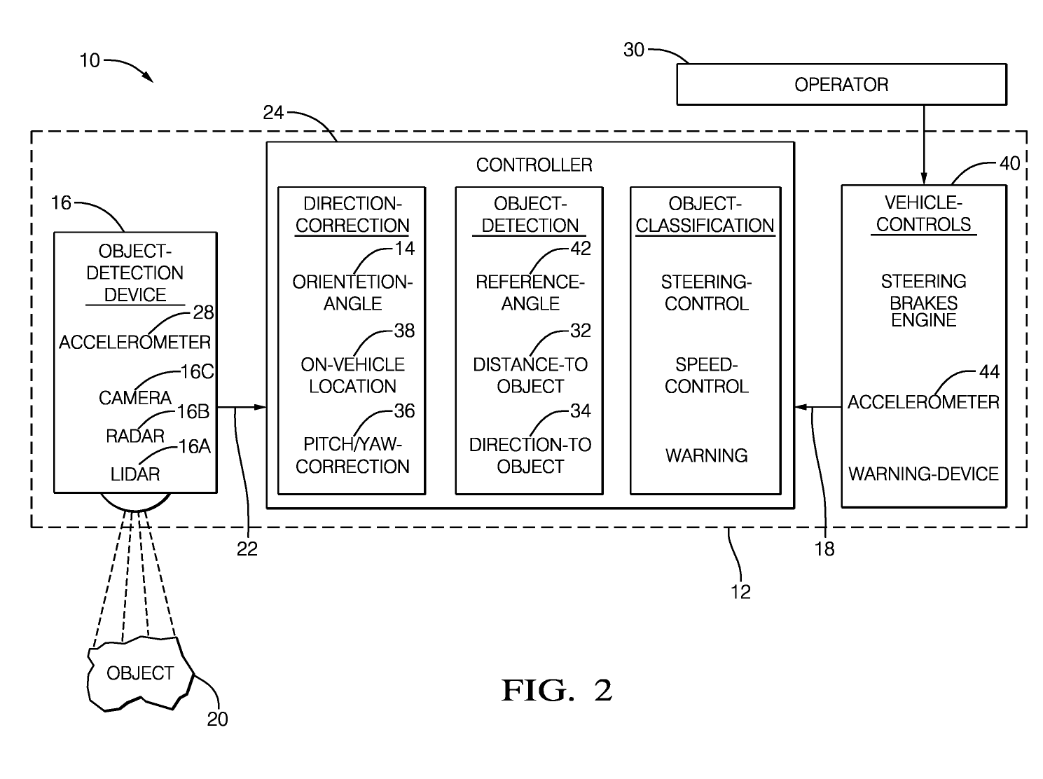

FIGS. 1-2 illustrate non-limiting examples of an object-detection system 10, hereafter referred to as the system 10, suitable for use on an automated vehicle, hereafter referred to as the vehicle 12. While the non-limiting examples given herein are generally directed to a fully automated vehicle, i.e. an autonomous vehicle, those in the art will recognize that the teachings presented herein will be useful on vehicles that are partially automated, i.e. vehicles that are generally driven by an operator 30, and the operator 30 is assisted to drive the vehicle by the system 10. The system 10 described herein overcomes the problems changes in an orientation-angle 14 indicative of a relative orientation of an object-detection device 16 relative to the vehicle 12 and/or a gravity-direction 18, i.e. the direction of gravity.

In general, the object-detection device 16 is configured to be installed on the vehicle 12 and is operable to detect an object 20 proximate to the vehicle 12. While multiple instances of the object-detection device 16 located at different locations on the vehicle 12 are contemplated, the example shown here has one instance only for the purpose of simplifying the drawings. Each instance of the object detection device 16 may include one or more of, but not limited to, and/or in any combination, a Light Detection And Ranging device (LIDAR 16A), Radio Detection And Ranging device (RADAR 16B), and imaging device, e.g. a video camera, hereafter the camera 16C. A detection-signal 22 output by the object-detection device 16 may be received and processed by a controller 24.

The controller 24 may include a processor (not specifically shown) such as a microprocessor or other control circuitry such as analog and/or digital control circuitry including an application specific integrated circuit (ASIC) for processing data as should be evident to those in the art. The controller 24 may include memory (not specifically shown), including non-volatile memory, such as electrically erasable programmable read-only memory (EEPROM) for storing one or more routines, thresholds, and captured data. The one or more routines may be executed by the processor to perform steps for determining if the detection-signals 22 received by the controller 24 need to include a pitch/yaw-correction 36 and thereby be corrected or compensated because the orientation-angle 14 (pitch angle, roll-angle, and/or yaw angle) relative to a road-angle of a roadway 26 (pitch angle and/or roll-angle) on which the vehicle 12 travels and/or relative to the gravity-direction 18 is other than expected, as will be described in more detail.

In order to determine the orientation-angle 14, the object-detection device advantageously includes an accelerometer 28 physically coupled, i.e. mechanically coupled, to the object-detection device 16. By way of example and not limitation, the accelerometer may be a Micro-Electro-Mechanical Systems (MEMS) type device such as MMA845xQ manufactured by Freescale Inc. The accelerometer 28 may be soldered to a circuit board assembly (not shown) within the object-detection device 16. In general, the accelerometer 28 is operable or is used to determine the orientation-angle 14 of the object-detection device 16. In one embodiment, the orientation-angle 14 is measured relative to the gravity-direction 18 which is illustrated as the orientation-angle 14A in FIG. 1. By way of further explanation, if the speed if the vehicle 12 is constant or is zero, any acceleration sensed by the accelerometer 28 can be attributed to the accelerometer 28 not being level, i.e. not perpendicular to the gravity-direction 18.

In one embodiment of the system 10, the orientation-angle 14 may be determined each time the vehicle 12 is started. In this circumstance, if the orientation-angle 14 indicated by the accelerometer 28 is measured soon after the vehicle 12 is started, the speed of the vehicle 12 can be assumed to be zero. In another embodiment, if the accelerometer 28 senses an acceleration (or deceleration) that is indicative of the vehicle 12 having been involved in a collision, e.g. acceleration greater than a predetermined threshold, the system 10 may be configured to determine the orientation-angle 14 after a vehicle-collision is detected. By checking the orientation-angle 14 soon after a collision, any change in the orientation-angle 14 caused by collision damage to the object-detection device 16 can be measured and possibly compensated.

It is recognized that that object-detection devices such as the camera 16C are sensitive to orientation when image data from the camera 16C is used to determine a distance 32 to the object 20 and/or a direction 34 to the object 20. It is also recognized that the on-vehicle location 38 can influence the degree to which the orientation-angle 14 can influence measurement or estimation of the distance 32 and/or the direction 34. By way of further explanation, a camera mounted high on the vehicle 12, adjacent to a rear-view mirror near the top of the windshield for example, will provide a perspective of the roadway and field-of-view proximate to the vehicle 12 that is less sensitive to error/change in orientation-angle than is the case if the camera is mounted low on the vehicle, near a bumper for example.

As suggested above, in one embodiment of the system 10, the object-detection device 16 is operable to determine the direction 34 and the distance 32 to the object 20 based on the orientation-angle 14A. However, in some circumstances such as when the vehicle 12 is parked facing up-hill/down-hill and/or when the trunk of the vehicle 12 is carrying a heavy load so the rear of the vehicle 12 squats, additional information may be necessary to accurately determine the orientation angle 14. As such, an alternative embodiment is contemplated where the system 10 includes a vehicle-module 40 operable to determine a reference-angle 42 of the vehicle 12 relative to the gravity-direction 18. That is, there is another level sensor such as a secondary-accelerometer 44 coupled or attached to the vehicle 12 in such a way that the reference angle 42 can be reliably determined.

Given the reference-angle 42, the orientation-angle 14B can be determined so that any misalignment of the object-detection device 16 can be determined independent of the effect of gravity on the accelerometer 28, and can be cancelled or compensated. For example, the system 10 may be configured to compare a desired-angle (not shown, but understood to be a predetermined value stored in memory of the controller) of the object-detection device 16 to the orientation-angle 14. If the difference is greater than a predetermined threshold, actions to warn the operator 30 and/or compensate information from the object-detection device 16 may be taken. That is, the system 10 may be configured so the object-detection device 16 is operable to determine the direction 34 and the distance 32 to the object 20 based on a difference between the desired-angle and the orientation-angle 14.

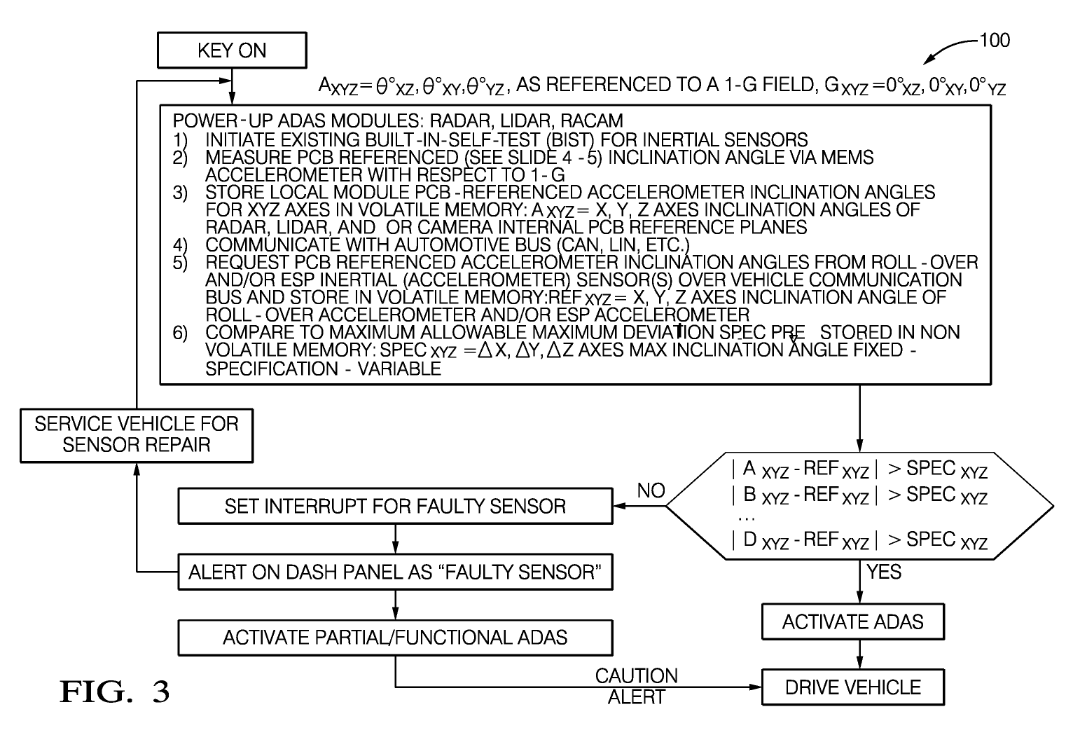

FIG. 3 illustrates a non-limiting example of a method 100 of operating the system 10. The object-detection device 16 may be misaligned with desired/required sensing planes with respect to reference axes (XYZ) of the vehicle 12. The cause may be installation misalignment, excessive vibration of attachment/mounting hardware, mounting hardware failure, and/or post-crash dent/misalignment near Advanced Driver Assisted System (ADAS) sensor (the object-detection device 16) mounting sites; catastrophic change of sensor reference plane angles. In this non-limiting example the accelerometer 28 is attached (e.g. soldered) to a printed circuit board (PCB), and the system includes the secondary-accelerometer 44 as part of an Electronic Stability Program (ESP) module mounted elsewhere on the vehicle 12. The method 100 shows one example of how instances of excess error in the orientation-angle 14 could be addressed.

Accordingly, an object-detection system (the system 10) suitable for an automated vehicle, a controller 24 for the system 10, and a method 100 of operating the system 10 is provided. Described herein is a Built-In-Self-Test (BIST) that can be used to determine if a RADAR/camera/LIDAR based version of the object-detection device 16 is functional upon vehicle start-up. The system 10 may compare a multi-axis accelerometer (inclinometer) angle data from RADAR/LIDAR PCB soldered package to Roll-Over and/or Anti-skid Electronic Stability Program (ESP) Module Accelerometers (via vehicle communication bus) for reference angle difference. The accelerometer 28 is used as inclinometer for Built-In-Self-Test (BIST) for RADAR/LIDAR/RACam (radar/camera combination) modules to verify sensing axes/planes are within specification as referenced to existing Roll-Over/ESP Module Accelerometer in a 1-g gravitational field. Accelerometer g-levels and high frequency data can be used to determine if excessive vibration or shock such as pot-holes require that Advanced Driver Assisted System (ADAS) data to be temporarily disregarded/re-sampled. Accelerometer g-levels and high frequency data can be used to determine if excessive vibration or shock (pot-holes) require remounting/tightening ADAS sensor attach hardware. Magnetic compass and inertial gyroscope sensors could also be added for additional sensor axes/plane positioning and vibration information, but may too expensive to do so, with less benefit than lower cost/power-consumption accelerometer/inclinometer. BIST for ADAS sensor position could also be repeated real-time (while driving) with a low duty cycle to conserve power and reduce communication bus traffic. Usage in vertical/azimuth auto alignment algorithm for improved accuracy of pre-ignition ADAS sensor calibration adjustments. Range/target plausibility verification/calibration, (or accuracy check), by comparing the results (when available) from satellite/distributed ADAS sensors on communication bus.

While this invention has been described in terms of the preferred embodiments thereof, it is not intended to be so limited, but rather only to the extent set forth in the claims that follow.

We claim:

1. An object-detection system suitable for an automated vehicle, said system comprising:
an object-detection device configured to be installed on a vehicle, said object-detection device operable to detect an object proximate to the vehicle; and
an accelerometer coupled to the object-detection device, said accelerometer operable to determine an orientation-angle of the object-detection device relative to a gravity-direction.

2. The system in accordance with claim 1, wherein the system determines the orientation-angle each time the vehicle is started.

3. The system in accordance with claim 1, wherein the system determines the orientation-angle after a vehicle-collision is detected.

4. The system in accordance with claim 1, wherein the object-detection device is operable to determine a direction and a distance to the object based on the orientation-angle.

5. The system in accordance with claim 1, wherein the system includes a vehicle-module operable to determine a reference-angle of the vehicle relative to the gravity-direction.

6. The system in accordance with claim 5, wherein the system compares a desired-angle of the object-detection device to the orientation-angle.

7. The system in accordance with claim 6, wherein the object-detection device is operable to determine a direction and a distance to the object based on a difference between the desired-angle and the orientation-angle.
